(19) United States
(12) Patent Application Publication
(10) Pub. No.: US 2018/0225355 A1
(43) Pub. Date: Aug. 9, 2018

(54) SELF-IMPROVING CLASSIFICATION

(71) Applicant: International Business Machines Corporation, Armonk, NY (US)

(72) Inventors: Nancy A. Greco, Lagrangeville, NY (US); Bong Jun Ko, Harrington Park, NJ (US); Maroun Touma, Redding, CT (US); Dinesh C. Verma, New Castle, NY (US); David A. Wood, Scarsdale, NY (US)

(21) Appl. No.: 15/426,465

(22) Filed: Feb. 7, 2017

(51) Int. Cl. G06F 17/30

(52) U.S. Cl. CPC G06F 17/30598; G06F 17/30345

(57) ABSTRACT

An approach for self-improving classification. The approach receives sensor data of a machine, wherein the sensor data is collected during operation of the machine. The approach defines one or more categories, wherein each category of the one or more categories is associated with one or more parameters. The approach determines whether the sensor data matches one or more parameters of a first category of the one or more categories. Responsive to a determination that the sensor data matches the one or more parameters of the first category, the approach classifies the sensor data into the first category. The approach applies a first category label to the sensor data, wherein the first category label is associated with the first category.

### BACKGROUND OF THE INVENTION

The present invention relates generally to the field of data classification, and more particularly to self-improving data classification systems.

Diagnostic data related to a machine, such as the sound it generates, ambient temperature, pressure, light, humidity, infrared transmission, and radio frequency transmission, can be invaluable in evaluating how well a machine is performing. Variation in machine performance can produce corresponding changes in diagnostics data. Diagnostic data can be used to optimize machine performance and diagnose problems.

Classification systems collect diagnostic data and use the diagnostic data to classify the machine status into one or more categories.

### SUMMARY

Aspects of an embodiment of the present invention disclose a method, computer program product, and a computer system for self-improving classification. The method may include receiving sensor data of a machine, wherein the sensor data is collected during operation of the machine. The method may further include defining one or more categories, wherein each category of the one or more categories is associated with one or more parameters. The method may further include determining whether the sensor data matches one or more parameters of a first category of the one or more categories. Responsive to a determination that the sensor data matches the one or more parameters of the first category, the method may further include classifying the sensor data into the first category. The method may further include applying a first category label to the sensor data, wherein the first category label is associated with the first category.

### BRIEF DESCRIPTION OF THE DRAWINGS

FIG. 1 is a functional block diagram illustrating a distributed data processing environment, in accordance with an embodiment of the present invention.

FIG. 2 is a flowchart depicting operational steps of a classification program, such as the classification program of FIG. 1, in accordance with an embodiment of the present invention.

FIG. 3 depicts a block diagram of components of a computer system capable of executing a classification program, such as the computing device of FIG. 1, in accordance with an embodiment of the present invention.

### DETAILED DESCRIPTION

Embodiments of the present invention recognize that changes in machine performance may manifest as measurable changes in diagnostic data associated with a machine output. Embodiments of the present invention recognize that large samples of machine diagnostic data may be classified to aid troubleshooting of machine performance. Embodiments of the present invention recognize that diagnostic data may define categories of performance.

Embodiments of the present invention provide the capability to classify machine performance according to shared characteristics in diagnostic data. Embodiments of the present invention provide the capability to define categories of machine performance with minimal training data. Embodiments of the present invention provide the capability to improve performance categories as additional diagnostic data is collected. Embodiments of the present invention provide the capability to request maintenance for a machine via an existing support system. Embodiments of the present invention provide the capability to improve performance categories based on maintenance feedback.

Implementation of embodiments of the invention may take a variety of forms, and exemplary implementation details are discussed subsequently with reference to the Figures. The present invention will now be described in detail with reference to the Figures.

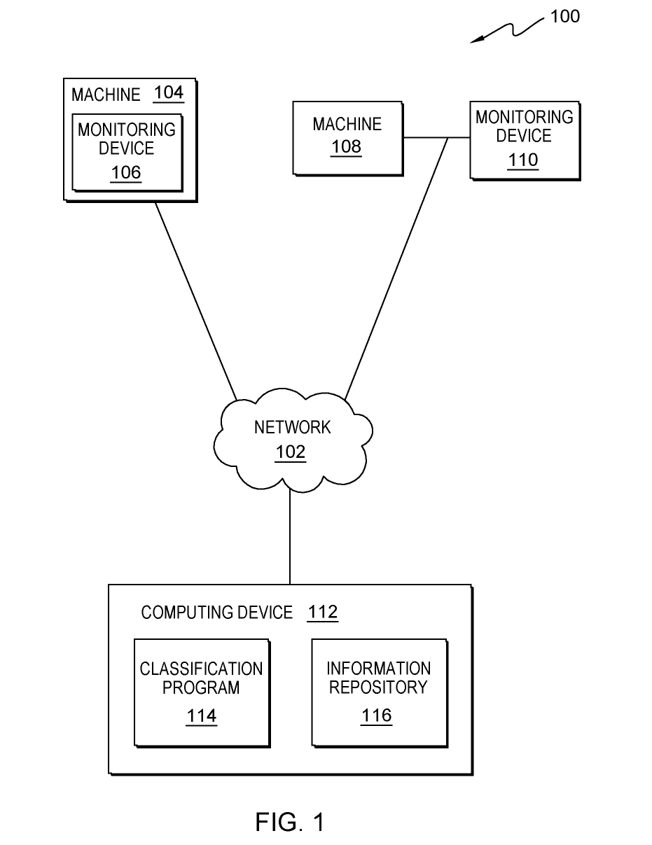

FIG. 1 is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Network 102 may be any combination of connections and protocols capable of supporting communications between machine 104, monitoring device 106, machine 108, monitoring device 110, and computing device 112. Network 102 may include wire cables, wireless communication links, fiber optic cables, routers, switches and/or firewalls. Monitoring device 106, monitoring device 110, and computing device 112 are interconnected by network 102. In one embodiment, network 102 may be the Internet, representing a worldwide collection of networks and gateways that use transmission control protocol/Internet protocol (TCP/IP) to communicate with one another. In other embodiments, network 102 may be implemented as a number of different types of networks, such as an intranet, a local area network (LAN), a virtual local area network (VLAN), or a wide area network (WAN). FIG. 1 is intended as an example and not as an architectural limitation for the different embodiments.

Machine 104 and machine 108 represent any type of machine, which performs a task or produces a product. For example, machine 104 and machine 108 may be engines in cars, air-conditioning equipment in a building, air-handling equipment in a building, printing presses, or cement mixing equipment in a factory. In one embodiment, machine 104 includes monitoring device 106. In another embodiment, machine 108 is connected to monitoring device 110 via a network, such as network 102.

Monitoring device 106 and monitoring device 110 represent any number of data collection devices, which can process data and communicate through network 102. In some embodiments, more than two monitoring devices may be present. Monitoring device 106 and monitoring device 110 may collect diagnostic data of one or more machines. For example, monitoring device 106 may contain a microphone to monitor the sound produced by an engine. In other examples, monitoring device 106 and monitoring device 110 may contain sensors to measure sound, light, infrared, radio, pressure, or humidity. In one embodiment, monitoring device 106 and monitoring device 110 are connected to machine 104 and machine 108 respectively to monitor machine 104 and machine 108 and collect diagnostic data from machine 104 and machine 108. For example, monitoring device 110 may be a temperature sensor connected to an air conditioner. In another embodiment, monitoring device 106 and monitoring device 110 are integrated into machinery to monitor the diagnostic data generated by the machinery. For example, monitoring device 106 may be a temperature sensor inside the blower of an air conditioner.

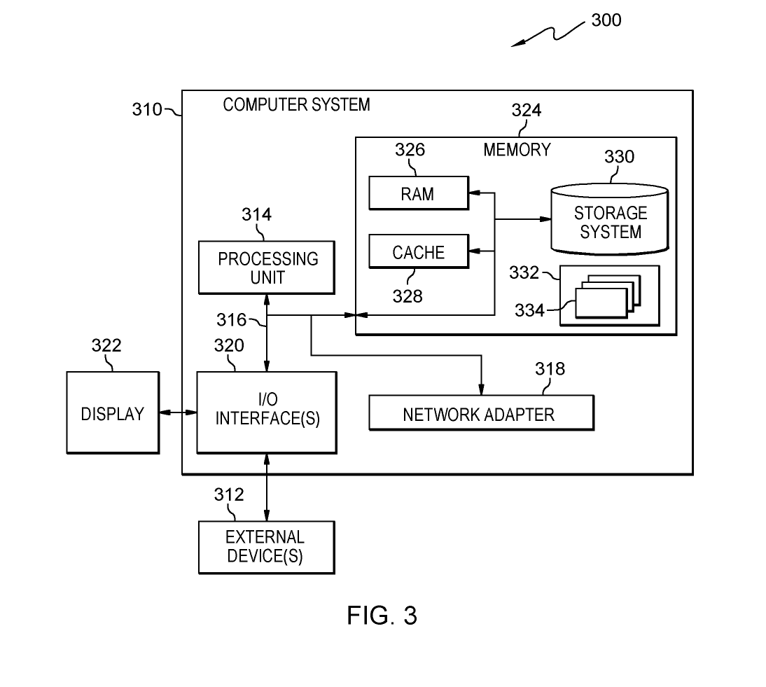

Computing device 112 may be a computer system such as a management server, a web server, or any other electronic device or computing system capable of sending and receiving data. In one embodiment, computing device 112 may be a data center, consisting of a collection of networks and servers providing an information technology (IT) service, such as virtual servers and applications deployed on virtual servers, to an external party. In another embodiment, computing device 112 represents a “cloud” of computers interconnected by one or more networks, where computing device 112 is a computing system utilizing clustered computers and components to act as a single pool of seamless resources when accessed through network 102. This is a common implementation for data centers in addition to cloud computing applications. In still another embodiment, computing device 112 may be a desktop computer, laptop computer, a tablet computer, mobile device, or any other electronic device or computing system capable of communicating with monitoring device 106 and monitoring device 110 through network 102. In one embodiment, computing device 112 represents a general-purpose computing device, such as computer system 310 of FIG. 3. In one embodiment, computing device 112 includes classification program 114 and information repository 116. In another embodiment, computing device 112 includes monitoring device 106 and monitoring device 110.

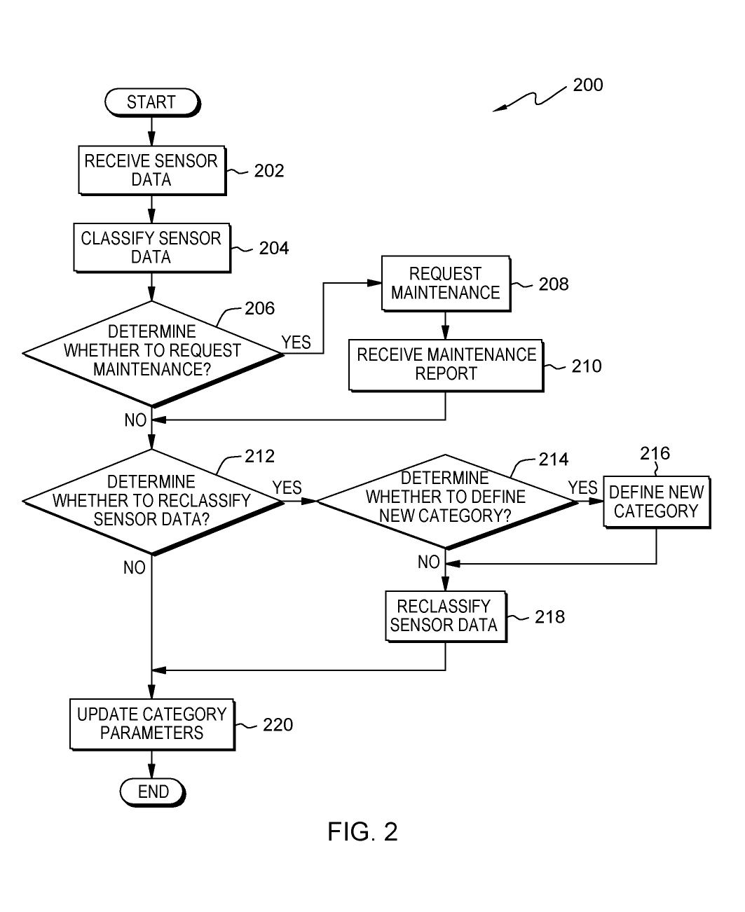

Classification program 114 may be a software-based application, operating on a computer system, for classifying machine diagnostic data. Classification program 114 may monitor, classify, and report on machine state based on diagnostic data of the machine. Classification program 114 may monitor machine performance by receiving sensor data from monitoring devices. For example, classification program 114 may receive audio recordings of machine 104 from monitoring device 106 via network 102. Classification program 114 may classify machine performance by comparing sensor data to data categories. For example, classification program 114 may classify an audio recording of a machine as “Normal” by comparing the audio recording to previous “Normal” recordings. Classification program 114 may report machine performance by storing sensor data to information repository 116. For example, classification program 114 may store a “Normal” audio recording of a machine to information repository 116, which can be accessed by a user. In one embodiment, classification program 114 may request maintenance via an existing infrastructure. For example, responsive to monitoring abnormal performance, classification program 114 may create a help ticket to request maintenance. In one embodiment, classification program 114 is executed by monitoring device 106 and monitoring device 110. The operations performed by classification program 114 are discussed further in the description of FIG. 2.

Information repository 116 may be persistent storage media on computing device 112, containing sensor data and metadata, such as data categories with corresponding labels. For example, information repository 116 may contain audio recordings from monitoring device 106, which are labelled “normal operation.” In one embodiment, information repository 116 contains raw sensor data. For example, information repository 116 may contain raw audio recordings of an engine, which were collected by monitoring device 106. In another embodiment, information repository 116 contains category criteria. For example, information repository 116 may contain a frequency range of 95 Hz to 105 Hz for normal operation of an engine. In one embodiment, information repository 116 contains environmental metadata. For example, information repository 116 may contain weather data, such as temperature, humidity, and pressure data, which describe the operating environment of the machine from which the sensor data was collected. In one embodiment, information repository 116 stores maintenance reports. For example, information repository 116 may store a maintenance report associated with sensor data of a machine, which includes a description of the repair performed on the machine.

Information repository 116 may be implemented using any volatile or non-volatile storage media for storing information, as known in the art. For example, information repository 116 may be implemented with a tape library, optical library, one or more independent hard disk drives, multiple hard disk drives in a redundant array of independent disks (RAID), solid-state drives (SSD), or random-access memory (RAM). Similarly, information repository 116 may be implemented with any suitable storage architecture known in the art, such as a relational database, an object-oriented database, or one or more tables.

In an embodiment, classification program 114 receives sensor data. In an embodiment, classification program 114 classifies the sensor data. In an embodiment, classification program 114 determines whether to request maintenance. In an embodiment, responsive to a determination to request maintenance, classification program 114 requests maintenance. In an embodiment, classification program 114 receives a maintenance report. In an embodiment, classification program 114 determines whether to reclassify the sensor data. In an embodiment, responsive to a determination to reclassify the sensor data, classification program 114 determines whether to define a new category. In an embodiment, responsive to a determination to define a new category, classification program 114 defines a new category. In an embodiment, classification program 114 reclassifies the sensor data. In an embodiment, classification program 114 updates the category parameters.

FIG. 2 is a flowchart, generally designated 200, depicting operational steps of a classification program, such as classification program 114, in accordance with an embodiment of the present invention. The operational steps are in an order according to one embodiment. In other embodiments, the functions noted in the flowchart can occur out of the order noted in FIG. 2. Modifications to the depicted order may be made by those skilled in the art without departing from the scope of the invention as recited by the claims.

Classification program 114 receives sensor data (202). Classification program 114 may receive sensor data by retrieving data from a monitoring device, such as monitoring device 106 and monitoring device 110. For example, classification program 114 may receive audio recordings of an engine from monitoring device 106. In one embodiment, classification program 114 receives raw sensor data. For example, classification program 114 may receive raw audio recordings from monitoring device 106. In another embodiment, classification program 114 receives characteristic information. For example, classification program 114 may receive amplitude, peak, frequency, harmonic, and transform information.

Classification program 114 classifies sensor data (204). Classification program 114 may classify sensor data by matching the characteristics of the sensor data to the parameters of a category. For example, classification program 114 may match an audio recording of an engine with a frequency of 100 Hz to a “Normal” category of 95 Hz to 105 Hz. In another example, classification program 114 may classify an audio recording of an engine with a frequency of 110 Hz as “Abnormal.” Classification program 114 may apply a label to the sensor data by writing a label to metadata associated with the sensor data. For example, classification program 114 may classify the sensor data as within a “Normal” category, and classification program 114 may write “Normal” to a category field in a header of the sensor data. In one embodiment, classification program 114 classifies any data that does not match a category as “Abnormal.” For example, where classification program 114 has only a single category of “Normal,” classification program 114 may classify sensor data that does not match the “Normal” category as “Abnormal.”

Classification program 114 determines whether to request maintenance (206). Classification program 114 may determine whether to request maintenance by determining the category of the sensor data. For example, responsive to classifying an audio recording of an engine as “Normal,” classification program 114 may determine not to request maintenance. In another example, responsive to classifying an audio recording of an engine as “Abnormal,” classification program 114 may determine to request maintenance. In one embodiment, classification program 114 receives rules from a user regarding when to request maintenance. For example, classification program 114 may receive a rule from a user to request maintenance for any sensor data that is not labelled “Normal.”

Responsive to a determination to request maintenance (“YES” branch 206), classification program 114 requests maintenance (208). In one embodiment, classification program 114 requests maintenance by submitting a request via an existing support system. For example, classification program 114 may submit a help ticket via an existing maintenance request system. In another embodiment, classification program 114 requests maintenance by sending a notification to a user. For example, classification program 114 may send an e-mail or text message to a maintenance technician. In still another embodiment, classification program 114 presents a warning on a machine in need of maintenance. For example, classification program 114 may illuminate a warning light or sound a warning buzzer via an instrument panel on a machine. In one embodiment, classification program 114 suggests a repair when requesting maintenance. For example, classification program 114 may suggest replacing a belt for an engine with sensor data that was classified into a “Faulty Belt” category.

Classification program 114 receives a maintenance report (210). Classification program 114 may receive a maintenance report by receiving a report, which contains a description of the maintenance performed. For example, classification program 114 may receive a maintenance report, which describes replacing a broken belt in an engine. In another example, classification program 114 may receive a maintenance report, which states that no repair was required.

In one embodiment, classification program 114 receives a maintenance report by retrieving a maintenance report from an existing support system. For example, classification program 114 may retrieve a maintenance report from an existing maintenance request system. In another embodiment, classification program 114 receives a maintenance report by receiving a notification from a maintenance technician. For example, classification program 114 may receive an e-mail or text message from a maintenance technician.

Responsive to a determination not to request maintenance (“NO” branch 206), classification program 114 determines whether to update the applied label (212), as described below.

Classification program 114 determines whether to reclassify the sensor data (212). Classification program 114 may determine whether to reclassify the sensor data by determining whether the category label applied to the sensor data is correct. For example, responsive to receiving a maintenance report that describes a completed repair, classification program 114 may determine that a “Normal” label applied to the sensor data is incorrect, and classification program 114 may determine to reclassify the sensor data into another category. In another example, responsive to not receiving a maintenance report, classification program 114 may determine that a “Normal” label applied to the sensor data is correct, and classification program 114 may determine not to reclassify the sensor data. In still another example, responsive to receiving a maintenance report that states that no problem was found, classification program 114 may determine that an “Abnormal” label applied to the sensor data is incorrect, and classification program 114 may determine to reclassify the sensor data as “Normal”.

In one embodiment, classification program 114 determines whether to reclassify the sensor data by determining whether the applied label matches a repair description in a maintenance report. For example, responsive to matching an applied label of “Faulty Belt” to a maintenance report that describes replacing a broken belt, classification program 114 may determine not to reclassify the sensor data. In another example, responsive to determining that an applied label of “Normal” does not match a maintenance report that describes completing a repair, classification program 114 may determine to reclassify the sensor data. In another embodiment, classification program 114 determines whether to reclassify sensor data based on one or more rules from a user. For example, classification program 114 may determine to reclassify sensor data that was labelled “Abnormal” based on a rule to reclassify any “Abnormal” sensor data in response to receiving a maintenance report.

Responsive to a determination to reclassify the sensor data (“YES” branch 212), classification program 114 determines whether to define a new category (214). Classification program 114 may determine whether to define a new category by determining whether a maintenance report matches an existing category. For example, responsive to a determination that a maintenance report description of “No problem found” matches a “Normal” label, classification program 114 may determine that the maintenance report matches an existing category, and classification program 114 may determine not to define a new category. In another example, responsive to a determination that a maintenance report that describes replacing a broken belt matches a “Faulty Belt” label, classification program 114 may determine that the maintenance report matches an existing category, and classification program 114 may determine not to define a new category. In still another example, responsive to a determination that a maintenance report that describes replacing a damaged gear does not match a “Normal” label or a “Faulty Belt” label, classification program 114 may determine that the maintenance report does not match an existing category, and classification program 114 may determine to define a new category.

In one embodiment, classification program 114 determines whether a maintenance report matches an existing category by determining whether a label matches an existing category label. For example, classification program 114 may determine whether a label in a maintenance report, which is selected from a list by a maintenance technician, matches an existing category, such as “Normal.” In another embodiment, classification program 114 uses natural language processing (NLP) to determine whether a maintenance report matches an existing category. For example, classification program 114 may use NLP to determine whether a written description in a maintenance report matches an existing category, such as “Faulty Belt.”

Responsive to a determination to define a new category (“YES” branch 214), classification program 114 defines a new category. Classification program 114 may define a new category by defining a new category label associated with one or more category parameters. For example, classification program 114 may define a “Faulty Gear” category label associated with an audio frequency of 80 HZ to 90 Hz.

In one embodiment, classification program 114 defines a new category based on input from a user. For example, classification program 114 may receive a label of “Faulty Gear” from a user to apply to a newly defined category associated with an audio frequency of 80 to 90 Hz. In another embodiment, classification program 114 defines a new category based on a rule from a user. For example, classification program 114 may define a “Faulty Gear” category, responsive to receiving three maintenance reports describing repairing a gear, based on a threshold rule to define a new category only after three similar maintenance reports are received. In still another embodiment, classification program 114 defines a new category based on an ontology. For example, classification program 114 may define a “Faulty Gear” label to apply to sensor data associated with maintenance reports that describe repairing a gear. In yet another embodiment, classification program 114 defines a new category using NLP. For example, responsive to receiving maintenance reports that describe repairing a gear or replacing a gear, classification program 114 may define a “Faulty Gear” label to apply to the sensor data associated with the maintenance reports.

In one embodiment, classification program 114 defines increasingly narrow categories across multiple iterations. For example, classification program 114 may define a broad “Faulty Gear” category in early iterations, and classification program 114 may define more narrow “Stripped Gear,” “Cracked Gear,” and “Broken Gear” categories in later iterations.

Responsive to a determination not to define a new category (“NO” branch 214), classification program 114 reclassifies the sensor data (218), as described below.

Classification program 114 reclassifies the sensor data (218). Classification program 114 may reclassify the sensor data by updating the label applied to the sensor data. For example, responsive to receiving a maintenance report that describes repairing a gear, classification program 114 may erase an “Abnormal” label associated with sensor data, and classification program 114 may write a “Faulty Gear” label associated with the sensor data. In another example, classification program 114 may erase an incorrect “Normal” label associated with sensor data, and classification program 114 may write a “Faulty Belt” label associated with the sensor data.

Responsive to a determination not to reclassify the sensor data (“NO” branch 212), classification program 114 updates category parameters (220), as described below.

Classification program 114 updates category parameters (220). Classification program 114 may update category parameters by altering the characteristic limits of a category. For example, classification program 114 may alter a “Normal” category of 95 Hz to 105 Hz for engine frequency to a “Normal” category of 95 Hz to 107 Hz in response to receiving a maintenance report that states that no problem was found with an engine frequency of 107 Hz. In another example, classification program 114 may alter a “Faulty Belt” category of 110 Hz to 120 Hz for engine frequency to a “Faulty Belt” category of 109 Hz to 120 Hz in response to receiving a maintenance report that describes repairing a belt for an engine with a frequency of 109 Hz.

FIG. 3 depicts a block diagram, generally designated 300, of components of a computer system capable of executing classification program 114, such as computing device 112, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

In one embodiment, computing device 112 in distributed data processing environment 100 is shown in the form of a general-purpose computing device, such as computer system 310. The components of computer system 310 may include, but are not limited to, one or more processors or processing unit 314, memory 324, and bus 316 that couples various system components including memory 324 to processing unit 314.

Bus 316 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 310 typically includes a variety of computer system readable media. Such media may be any available media that is accessible by computer system 310, and it includes both volatile and non-volatile media, removable and non-removable media.

Memory 324 can include computer system readable media in the form of volatile memory, such as random access memory (RAM) 326 and/or cache memory 328. Computer system 310 may further include other removable/non-removable, volatile/non-volatile computer system storage media. By way of example only, storage system 330 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 316 by one or more data media interfaces. As will be further depicted and described below, memory 324 may include at least one computer program product having a set (e.g., at least one) of program modules that are configured to carry out the functions of embodiments of the invention.

Program/utility 332, having one or more sets of program modules 334, may be stored in memory 324 by way of example, and not limitation, as well as an operating system, one or more application programs, other program modules, and program data. Each of the operating systems, one or more application programs, other program modules, and program data, or some combination thereof, may include an implementation of a networking environment. Program modules 334 generally carry out the functions and/or methodologies of embodiments of the invention as described herein. Computer system 310 may also communicate with one or more external device(s) 312 such as a keyboard, a pointing device, a display 322, etc., or one or more devices that enable a user to interact with computer system 310 and any devices (e.g., network card, modem, etc.) that enable computer system 310 to communicate with one or more other computing devices. Such communication can occur via Input/Output (I/O) interface(s) 320. Still yet, computer system 310 can communicate with one or more networks such as a local area network (LAN), a general wide area network (WAN), and/or a public network (e.g., the Internet) via network adapter 318. As depicted, network adapter 318 communicates with the other components of computer system 310 via bus 316. It should be understood that although not shown, other hardware and software components, such as microcode, device drivers, redundant processing units, external disk drive arrays, RAID systems, tape drives, and data archival storage systems may be used in conjunction with computer system 310.

As used herein, “application,” “mobile application,” or “app” encompasses application software that runs on (or is capable of running on) mobile devices and performs specific tasks for a user of the mobile device. In general, applications encompass any software file comprising instructions that can be understood and processed on a computing device, such as, for example, executable files, library modules, object files, script files, interpreter files, executable modules and the like. An application may be capable of being decompiled (decompiling is a process of translating a file, such as an executable file, containing information at a relatively low level of abstraction, such as assembly language, into a higher level of abstraction that may be human readable, such as programming languages like C++). Applications may include native applications (pre-installed on the mobile device by a vendor) such as address books, calendars, calculators, games, maps, and web browsers. Applications may also be downloaded from a plurality of application software distribution platforms via a network for execution on a mobile device, such as efficient booting system.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A method for self-improving classification, the method comprising:
receiving, by one or more computer processors, sensor data of a machine, wherein the sensor data is collected during operation of the machine;
defining, by the one or more computer processors, one or more categories, wherein each category of the one or more categories is associated with one or more parameters;
determining, by the one or more computer processors, whether the sensor data matches one or more parameters of a first category of the one or more categories;
responsive to a determination that the sensor data matches the one or more parameters of the first category, classifying, by the one or more computer processors, the sensor data into the first category; and
applying, by the one or more computer processors, a first category label to the sensor data, wherein the first category label is associated with the first category.

2. The method of claim 1, further comprising:
responsive to a determination that the sensor data does not match the one or more parameters of the first category, requesting, by the one or more computer processors, maintenance of the machine, wherein requesting maintenance includes at least one of:
transmitting, by the one or more computer processors, a notification to a user,
illuminating, by the one or more computer processors, a warning light,
sounding, by the one or more computer processors, an audio warning, and
submitting, by the one or more computer processors, a request via a support system.

3. The method of claim 2, further comprising:
receiving, by the one or more computer processors, user input from the user, wherein the user input includes the maintenance of the machine;
determining, by the one or more computer processors, whether to reclassify the sensor data based on the user input, wherein determining includes determining whether the first category label applied to the sensor data matches the user input;
responsive to a determination that the first category label does not match the user input, determining, by the one or more computer processors, to reclassify the sensor data;
responsive to a determination to reclassify the sensor data, determining, by the one or more computer processors, whether the user input matches a second category of the one or more categories; and
responsive to a determination that the user input matches the second category, reclassifying, by the one or more computer processors, the sensor data into the second category, wherein reclassifying includes removing the first category label associated with the first category and applying a second category label associated with the second category.

4. The method of claim 3, further comprising:
responsive to a determination that the user input does not match the second category, defining, by the one or more computer processors, a third category of the one or more categories, wherein defining the third category includes:
determining one or more category parameters associated with the third category based on the sensor data, and
determining the third category label associated with the third category based on the user input.

5. The method of claim 4, wherein determining the third category label, comprises at least one of:
determining the third category label based on the user input;
determining the third category label based on an ontology; and
determining the third category label based on natural language processing of the user input.

6. The method of claim 1, further comprising:
receiving, by the one or more computer processors, input from a user; and
updating, by the one or more computer processors, the one or more category parameters based on the input from the user.

7. The method of claim 1, wherein the sensor data, comprises at least one of:
sound, light, infrared, radio, pressure, humidity, and temperature measurements.

8. A computer program product for self-improving classification, the computer program product comprising:
one or more computer readable storage media and program instructions stored on the one or more computer readable storage media, the stored program instructions comprising:
program instructions to receive sensor data of a machine, wherein the sensor data is collected during operation of the machine;
program instructions to define one or more categories, wherein each category of the one or more categories is associated with one or more parameters;
program instructions to determine whether the sensor data matches one or more parameters of a first category of the one or more categories;
responsive to a determination that the sensor data matches the one or more parameters of the first category, program instructions to classify the sensor data into the first category; and
program instructions to apply a first category label to the sensor data, wherein the first category label is associated with the first category.

9. The computer program product of claim 8, further comprising:
responsive to a determination that the sensor data does not match the one or more parameters of the first category, program instructions to request maintenance of the machine, wherein the program instructions to request maintenance include at least one of:
program instructions to transmit a notification to a user,
program instructions to illuminate a warning light,
program instructions to sound an audio warning, and
program instructions to submit a request via a support system.

10. The computer program product of claim 9, further comprising:
program instructions to receive user input from the user, wherein the user input includes the maintenance of the machine;
program instructions to determine whether to reclassify the sensor data based on the user input, wherein the program instructions to determine include program instructions to determine whether the first category label applied to the sensor data matches the user input;
responsive to a determination that the first category label does not match the user input, program instructions to determine to reclassify the sensor data;
responsive to a determination to reclassify the sensor data, program instructions to determine whether the user input matches a second category of the one or more categories; and
responsive to a determination that the user input matches the second category, program instructions to reclassify the sensor data into the second category, wherein the program instructions to reclassify include program instructions to remove the first category label associated with the first category and program instructions to apply a second category label associated with the second category.

11. The computer program product of claim 10, further comprising:
responsive to a determination that the user input does not match the second category, program instructions to define a third category of the one or more categories, wherein the program instructions to define the third category include:
program instructions to determine one or more category parameters associated with the third category based on the sensor data, and
program instructions to determine the third category label associated with the third category based on the user input.

12. The computer program product of claim 11, wherein the program instructions to determine the third category label, comprise at least one of:
program instructions to determine the third category label based on the user input;
program instructions to determine the third category label based on an ontology; and
program instructions to determine the third category label based on natural language processing of the user input.

13. The computer program product of claim 8, further comprising:
program instructions to receive input from a user; and
program instructions to update the one or more category parameters based on the input from the user.

14. The computer program product of claim 8, wherein the sensor data, comprises at least one of:
sound, light, infrared, radio, pressure, humidity, and temperature measurements.

15. A computer system for self-improving classification, the computer system comprising:
one or more computer processors;
one or more computer readable storage media;
and program instructions stored on the one or more computer readable storage media, the stored program instructions comprising:
program instructions to receive sensor data of a machine, wherein the sensor data is collected during operation of the machine;
program instructions to define one or more categories, wherein each category of the one or more categories is associated with one or more parameters;
program instructions to determine whether the sensor data matches one or more parameters of a first category of the one or more categories;
responsive to a determination that the sensor data matches the one or more parameters of the first category, program instructions to classify the sensor data into the first category; and
program instructions to apply a first category label to the sensor data, wherein the first category label is associated with the first category.

16. The computer system of claim 15, further comprising:
responsive to a determination that the sensor data does not match the one or more parameters of the first category, program instructions to request maintenance of the machine, wherein the program instructions to request maintenance include at least one of:
program instructions to transmit a notification to a user,
program instructions to illuminate a warning light,
program instructions to sound an audio warning, and
program instructions to submit a request via a support system.

17. The computer system of claim 16, further comprising:
program instructions to receive user input from the user, wherein the user input includes the maintenance of the machine;
program instructions to determine whether to reclassify the sensor data based on the user input, wherein the program instructions to determine include program instructions to determine whether the first category label applied to the sensor data matches the user input;
responsive to a determination that the first category label does not match the user input, program instructions to determine to reclassify the sensor data;
responsive to a determination to reclassify the sensor data, program instructions to determine whether the user input matches a second category of the one or more categories; and
responsive to a determination that the user input matches the second category, program instructions to reclassify the sensor data into the second category, wherein the program instructions to reclassify include program instructions to remove the first category label associated with the first category and program instructions to apply a second category label associated with the second category.

18. The computer system of claim 17, further comprising:
responsive to a determination that the user input does not match the second category, program instructions to define a third category of the one or more categories, wherein the program instructions to define the third category include:
program instructions to determine one or more category parameters associated with the third category based on the sensor data, and
program instructions to determine the third category label associated with the third category based on the user input.

19. The computer system of claim 15, further comprising:
program instructions to receive input from a user; and
program instructions to update the one or more category parameters based on the input from the user.

20. The computer system of claim 15, wherein the sensor data, comprises at least one of:
sound, light, infrared, radio, pressure, humidity, and temperature measurements.
